(19) United States
(12) Patent Application Publication
(10) Pub. No.: US 2022/0284793 A1
(43) Pub. Date: Sep. 8, 2022

(54) HAND WASHING COUNTDOWN DEVICE

(71) Applicant: Jose Cruz, Albany, NY (US)

(72) Inventor: Jose Cruz, Albany, NY (US)

(21) Appl. No.: 17/194,377

(22) Filed: Mar. 8, 2021

(51) Int. Cl. G08B 21/24; G06F 3/14; G08B 7/06

(52) U.S. Cl. CPC G08B 21/245; G06F 3/14; G08B 7/06

(57) ABSTRACT

A hand washing countdown device, including a main body disposed within a distance of a sink, a display unit disposed on at least a portion of a front surface of the main body to display a timer thereon, at least one sensor disposed within at least a portion of the main body and connected to the display unit to detect use of the sink, such that the display unit decrements the timer in response to the at least one sensor detecting the sink being used, and a speaker disposed on at least a portion of the front surface of the main body to emit at least one sound therefrom in response to the timer on the display unit reaching zero.

### BACKGROUND

### 1. Field

The present general inventive concept relates generally to a countdown device, and particularly, to a hand washing countdown device.

### 2. Description of the Related Art

Currently, preserving public health safety is a primary concern in society. Specifically, the worldwide pandemic due to coronavirus disease 2019 (COVID-19) has placed an increased emphasis on practicing proper hygiene protocols. The United States Centers for Disease Control and Prevention (CDC) has issued many guidelines for proper hygiene including washing hands for at least twenty seconds after coming in contact with hard surfaces to guarantee all the virus is killed. When a person does not adhere to the correct hygiene protocols, not only is the person putting himself or herself at risk of virus infection, but the public as whole.

Typically, public restrooms do not include a timer of any kind. Even if the person has a watch and/or a mobile device that includes a clock, the person is unlikely to observe the watch and/or the mobile device to determine how long the person has been washing hands.

Therefore, there is a need for a hand washing countdown device to display to the person washing hands a recommended time for washing to ensure proper hygiene.

### SUMMARY

The present general inventive concept provides a hand washing countdown device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a hand washing countdown device, including a main body disposed within a distance of a sink, a display unit disposed on at least a portion of a front surface of the main body to display a timer thereon, at least one sensor disposed within at least a portion of the main body and connected to the display unit to detect use of the sink, such that the display unit decrements the timer in response to the at least one sensor detecting the sink being used, and a speaker disposed on at least a portion of the front surface of the main body to emit at least one sound therefrom in response to the timer on the display unit reaching zero.

The display unit may stop decrementing the timer and resets the timer in response to the at least one sensor detecting a lack of use of the sink.

The at least one sensor may detect use of the sink based on movement within a predetermined distance away from the at least one sensor.

The at least one sensor may detect use of the sink based on a presence of a sound of water running from a sink within a predetermined distance from the at least one sensor.

The hand washing countdown device may further include a setting button disposed on at least a portion of the front surface of the main body to set the timer.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a front perspective view of a hand washing countdown device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURES, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Hand Washing Countdown Device 100
Main Body 110
Display Unit 120
Sensor 130
Speaker 140
Setting Button 150
Power Source 160
Fastener 170

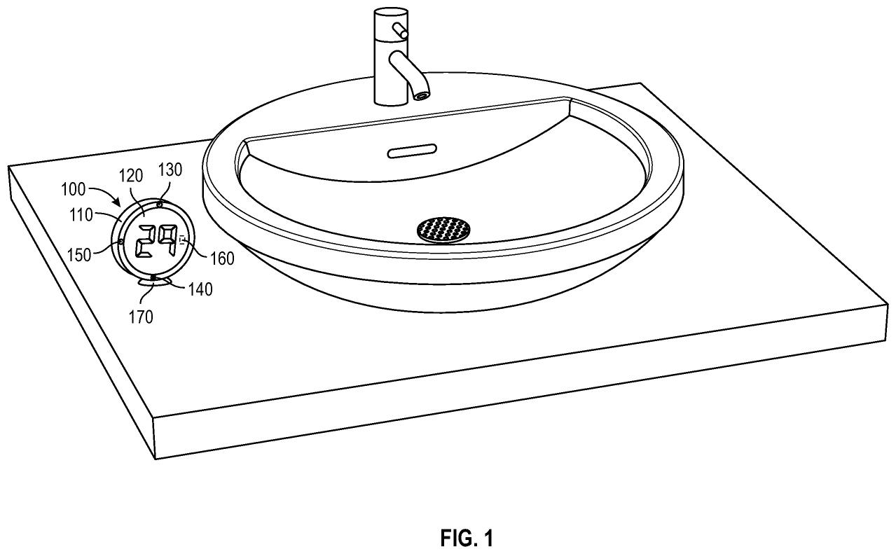

FIG. 1 illustrates a front perspective view of a hand washing countdown device 100, according to an exemplary embodiment of the present general inventive concept.

The hand washing countdown device 100 may be constructed from at least one of metal, plastic, wood, glass, and rubber, etc., but is not limited thereto. Moreover, the hand washing countdown device 100 may be highly durable (e.g., resistant to damage) and waterproof.

The hand washing countdown device 100 may include a main body 110, a display unit 120, at least one sensor 130, a speaker 140, a setting button 150, a power source 160, and a fastener 170, but is not limited thereto.

Referring to FIG. 1, the main body 110 is illustrated to have a cylindrical shape. However, the main body 110 may be a rectangular prism, circular, conical, triangular, pentagonal, hexagonal, heptagonal, octagonal, or any other shape known to one of ordinary skill in the art, but is not limited thereto.

The main body 110 may be disposed on and/or within a distance away from a sink and/or a mirror in a bathroom.

The display unit 120 may include an analog clock face, a plasma screen, an LCD screen, a light emitting diode (LED) screen, an organic LED (OLED) screen, a computer monitor, a hologram output unit, a sound outputting unit, or any other type of device that visually or aurally displays data.

The display unit 120 may be disposed on at least a portion of a front surface of the main body 110. The display unit 120 may display a timer thereon. Moreover, the timer may be based on a predetermined amount of time, such as twenty seconds and/or twenty-four seconds.

The at least one sensor 130 may include a movement sensor, a temperature sensor, and/or a sound sensor, but is not limited thereto.

The at least one sensor 130 may be disposed on and/or within at least a portion of the main body 110 and connected to the display unit 120. The at least one sensor 130 may detect use of the sink, such as movement (e.g., a user approaching the sink and/or hands of the user within the sink) within a predetermined distance away from the at least one sensor 130, such as one foot, two feet, three feet, etc. Alternatively, and/or in addition thereto, the at least one sensor 130 may detect a presence of a sound of water running from a sink within the predetermined distance from the at least one sensor 130 due to the water running from the sink being specific to the sink. In other words, the at least one sensor 130 may ignore the sound of water from another sink beyond the predetermined distance from the at least one sensor 130.

Therefore, the display unit 120 may decrement the timer beginning from the predetermined amount of time down to zero in response to the at least one sensor 130 detecting the sink being used. As such, the display unit 120 and/or the at least one sensor 130 may guide a length of time for the user to wash hands. Also, the display unit 120 may stop the timer and/or reset the timer in response to the at least one sensor 130 detecting a lack of use of the sink, such as the user leaving the predetermined distance away from the at least one sensor 130 and/or the at least one sensor 130 detecting an absence of the sound of water from the sink within the predetermined distance from the at least one sensor 130.

The speaker 140 may be disposed on at least a portion of the front surface of the main body 110. The speaker 140 may emit at least one sound therefrom in response to the timer on the display unit 120 reaching zero. For example, the speaker 140 may emit a cheer sound, a congratulatory music, a chime, a bell, and/or a congratulatory word. Also, the speaker 140 may emit at least one other sound therefrom in response to the timer on the display unit 120 being stopped. As such, the speaker 140 may emit a boo sound and/or an expression of disappointment.

The setting button 150 may be disposed on at least a portion of the front surface of the main body 110. The setting button 150 may set the predetermined amount of time for the timer, such as between twenty seconds and/or twenty-four seconds. Alternatively, the setting button 150 may alternate a display of the display unit 120 from a digital clock to an analog clock.

The power source 160 may include a battery and a solar cell, but is not limited thereto.

The power source 160 may be disposed within at least a portion of the main body 110. The power source 160 may provide power to the display unit 120, the at least one sensor 130, the speaker 140, and/or the setting button 150.

Referring again to FIG. 1, the fastener 170 is illustrated to be a suction cup. However, the fastener 160 may be a clip, a clasp, an adhesive, a magnet, and/or any combination thereof, but is not limited thereto.

The fastener 170 may be removably disposed on at least a portion of a cylindrical surface of the main body 110. Alternatively, the fastener 170 may be removably disposed on at least a portion of a rear surface of the main body 110 opposite with respect to the front surface of the main body 110. The fastener 170 may connect the main body 110 to an external surface (e.g., the sink, a countertop, a table, a wall, a mirror, etc.).

Therefore, the hand washing countdown device 100 may ensure proper hygiene for the user washing hands.

The present general inventive concept may include a hand washing countdown device 100, including a main body 110 disposed within a distance of a sink, a display unit 120 disposed on at least a portion of a front surface of the main body 110 to display a timer thereon, at least one sensor 130 disposed within at least a portion of the main body 110 and connected to the display unit 120 to detect use of the sink, such that the display unit 120 decrements the timer in response to the at least one sensor 130 detecting the sink being used, and a speaker 140 disposed on at least a portion of the front surface of the main body 110 to emit at least one sound therefrom in response to the timer on the display unit 120 reaching zero.

The display unit 120 may stop decrementing the timer and resets the timer in response to the at least one sensor 130 detecting a lack of use of the sink.

The at least one sensor 130 may detect use of the sink based on movement within a predetermined distance away from the at least one sensor 130.

The at least one sensor 130 may detect use of the sink based on a presence of a sound of water running from a sink within a predetermined distance from the at least one sensor 130.

The hand washing countdown device 100 may further include a setting button 150 disposed on at least a portion of the front surface of the main body 110 to set the timer.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A hand washing countdown device, comprising:
a main body disposed within a distance of a sink;
a display unit disposed on at least a portion of a front surface of the main body to display a timer thereon;
at least one sensor disposed within at least a portion of the main body and connected to the display unit to detect use of the sink and ignores a sound of water of another sink beyond a predetermined distance away from the at least one sensor, such that the display unit decrements the timer in response to the at least one sensor detecting the sink being used, such that the at least one sensor ignores the sound of water of the another sink based only on the predetermined distance away therefrom; and
a speaker disposed on at least a portion of the front surface of the main body to emit at least one sound therefrom in response to the timer on the display unit reaching zero.

2. The hand washing countdown device of claim 1, wherein the display unit stops decrementing the timer and resets the timer in response to the at least one sensor detecting a lack of use of the sink.

3. The hand washing countdown device of claim 1, wherein the at least one sensor detects use of the sink based on movement within the predetermined distance away from the at least one sensor.

4. The hand washing countdown device of claim 1, wherein the at least one sensor detects use of the sink based on a presence of a sound of water running from the sink within the predetermined distance from the at least one sensor.

5. The hand washing countdown device of claim 1, further comprising:
a setting button disposed on at least a portion of the front surface of the main body to set the timer.

6. A hand washing countdown device, comprising:
a main body disposed within a distance of a first sink;
a display unit disposed on at least a portion of a front surface of the main body to display a timer thereon;
at least one sensor disposed within at least a portion of the main body and connected to the display unit to detect use of the first sink within a predetermined distance of the at least one sensor and prevent detection of use of a second sink different from the first sink, such that the display unit decrements the timer in response to the at least one sensor detecting the first sink being used, such that the at least one sensor prevents detection of use of the second sink based only on the predetermined distance away therefrom; and
a speaker disposed on at least a portion of the front surface of the main body to emit at least one sound therefrom in response to the timer on the display unit reaching zero.
